(19) United States
(12) Patent Application Publication
(10) Pub. No.: US 2013/0060795 A1
(43) Pub. Date: Mar. 7, 2013

(54) PREPARED STATEMENTS TO IMPROVE PERFORMANCE IN DATABASE INTERFACES

(71) Applicants: James M. Plasek, Shoreview, MN (US); Michael S. Jende, White Bear Lake, MN (US); Ronald H. Menzhuber, New Brighton, MN (US); Jennifer J. Smith, Eden Prairie, MN (US)

(72) Inventors: James M. Plasek, Shoreview, MN (US); Michael S. Jende, White Bear Lake, MN (US); Ronald H. Menzhuber, New Brighton, MN (US); Jennifer J. Smith, Eden Prairie, MN (US)

(73) Assignee: Unisys Corp., Blue Bell, PA (US)

(21) Appl. No.: 13/226,526

(22) Filed: Sep. 7, 2011

(51) Int. Cl. G06F 17/30

(52) U.S. Cl. 707/755; 707/E17.058

(57) ABSTRACT

Performance of database systems may be improved by reducing the processing performed with each database query. For example, when a database query, such as a SQL statement, is executed with a first set of values, the query may be stored as a prepared statement and parsed and optimized as a section. When a similar database query is executed with a new set of values the section may be re-executed with the new set of values without re-parsing or re-optimizing the prepared statement. A similar database query may continue to be executed with new sets of values until the section is invalid because of an alteration to the table definitions of the database schema.

### TECHNICAL FIELD

The instant disclosure relates to databases. More specifically, the instant disclosure relates to executing queries in databases.

### BACKGROUND

Database systems allow for storage of and rapid access to large sets of information. Database systems have become an important part of organizing information within companies. Additionally, database systems have made available large amounts of information, such as news stories, through web sites on the Internet. Data in a database system may be selected and fetched through query statements executed by the database system. After a query is executed by a requester, a set of data is returned to the requester, if the data is available. Database systems frequently execute similar or identical queries. For example, in a database system storing patient records the queries are frequently of the type: “find all drugs patient X is allergic to.” In another example, in a database system storing information for a news website the queries are frequently of the type: “find all news stories for today's date in the world news category.”

Executing a query on a database system involves several steps such as converting the query to a language the database system understands, parsing the query, optimizing the query, and finally executing the query. FIG. 1 is a flow chart illustrating a conventional series of database queries. A method 100 begins at block 102 with a user setting a first database query with a first set of values. The first set of values may be, for example, a date and a category for retrieving news articles. Initially, the query may be converted from UNICODE to ASCII. At block 104 the ASCII query may be parsed. Then, at block 106 the parsed query is optimized. And, finally, at block 108 the optimized query is executed in the database system and data, such as news articles for the requested date and category, is returned to the user.

A second request to the database system may be substantially the same request, but with a different date and/or a different category. For example, the second request may be: “find all news stories for today's date in the local news category.” Although this request is the same as the first request, except with a different category, the database system will have to repeat each of the steps described above to execute the query. At block 110 the first database query is set with the second set of values. At block 112 the first database query is again parsed. Then, at block 114 the first database query is again optimized. And, finally, at block 116 the first database query is executed with the second set of values and the data is returned to the user.

Up to and exceeding half the time consumed by the database system in executing a query may be taken by the parsing and optimizing steps. Thus, the efficiency, capacity, and throughput of a database system may be significantly improved if the steps for executing repetitive queries may be optimized.

One prior solution for improving database systems executing repetitive queries is caching. That is, when a second database query is executed a short time after an identical first database query, the results from the query may be stored for a short time in memory. Thus, when the second database query is executed, the database system may recognize that the second query is identical to the first and fetch the results from memory. Fetching results from memory reduces the time consumed in executing a query, but does not reduce the time consumed in preparing the request. Additionally, caching data only improves performance of identical queries requesting the same data. Caching does not improve performance of similar queries asking for different data. Furthermore, cached data can become out-of-date if the database system is frequently being updated, such as in a database storing stock prices.

### SUMMARY

According to one embodiment, a method includes storing a prepared statement having at least one variable for execution by a database interface in a database. The method also includes assigning at least one first value to the at least one variable. The method further includes parsing the prepared statement. The method also includes executing the parsed prepared statement with the at least one first value. The method further includes assigning at least one second value to the at least one variable. The method also includes executing the parsed prepared statement with the at least one second value.

According to another embodiment, a computer program product includes a non-transitory computer readable medium having code to store a prepared statement having at least one variable for execution by a database interface in a database. The medium also includes code to assign at least one first value to the at least one variable. The medium further includes code to parse the prepared statement. The medium also includes code to execute the parsed prepared statement with the at least one first value. The medium further includes code to assign at least one second value to the at least one variable. The medium also includes code to execute the parsed prepared statement with the at least one second value.

According to a further embodiment, a system includes a processor coupled to a memory, in which the processor is configured to store a prepared statement having at least one variable for execution by a database interface in a database. The processor is also configured to assign at least one first value to the at least one variable. The processor is further configured to parse the prepared statement. The processor is also configured to execute the parsed prepared statement with the at least one first value. The processor is further configured to assign at least one second value to the at least one variable. The processor is also configured to execute the parsed prepared statement with the at least one second value.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a conventional series of database queries.

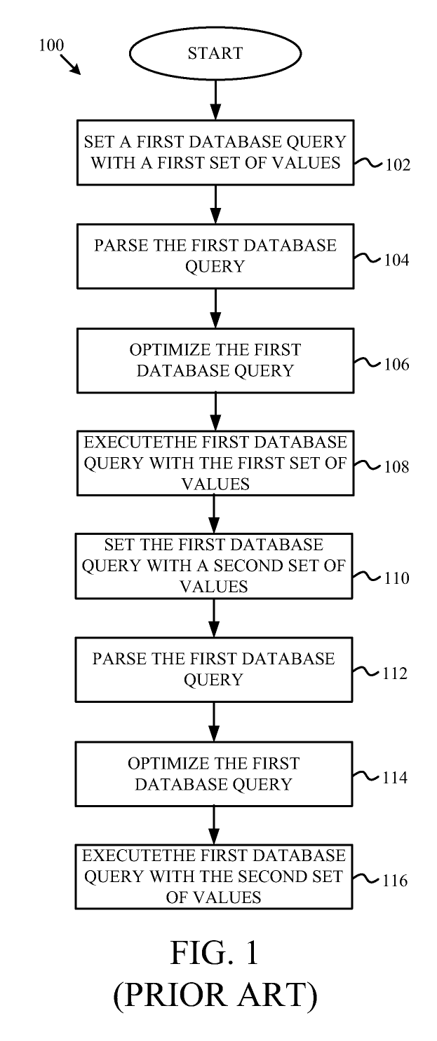

FIG. 2 is a flow chart illustrating execution of a series of database queries with a prepared statement according to one embodiment of the disclosure.

FIG. 3 is source code illustrating storing and executing a prepared statement with two sets of values according to one embodiment of the disclosure.

FIG. 4 is source code illustrating executing a prepared insert statement according to one embodiment of the disclosure.

FIG. 5 is source code illustrating executing a statement with a defined cursor according to one embodiment of the disclosure.

FIG. 6 is source code illustrating executing a statement with a defined cursor according to another embodiment of the disclosure.

FIG. 7 is block diagram illustrating a data management system configured to store databases, tables, and/or records according to one embodiment of the disclosure.

FIG. 8 is a block diagram illustrating a data storage system according to one embodiment of the disclosure.

FIG. 9 is a block diagram illustrating a computer system according to one embodiment of the disclosure.

### DETAILED DESCRIPTION

Efficiency for querying databases may be improved by storing the query as a prepared statement and parsing the prepared statement once for multiple queries. For example, the query may include two variables, such as a date for news articles and a category for news articles to be retrieved from a database. The query may be stored as a prepared statement that is parsed and optimized once and executed multiple times with different values. The prepared statement may continue to be executed with new values until the database is altered such that the prepared statement should be re-parsed and re-optimized. After the database is altered, the prepared statement may be re-parsed, re-optimized, and again executed multiple times with different values without re-parsing the prepared statement. By reducing the number of parsing steps and optimization steps by re-using the prepared statement, database performance is increased and processor utilization is decreased.

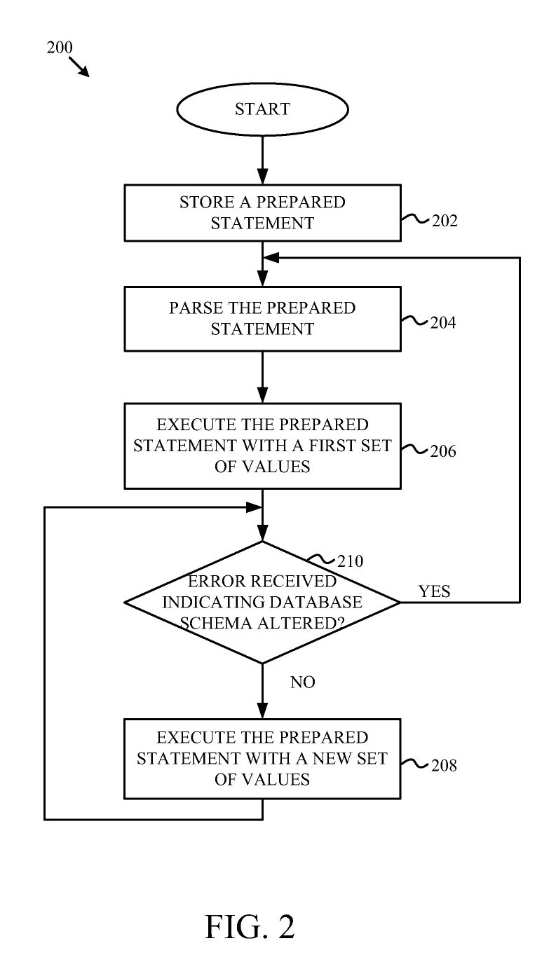

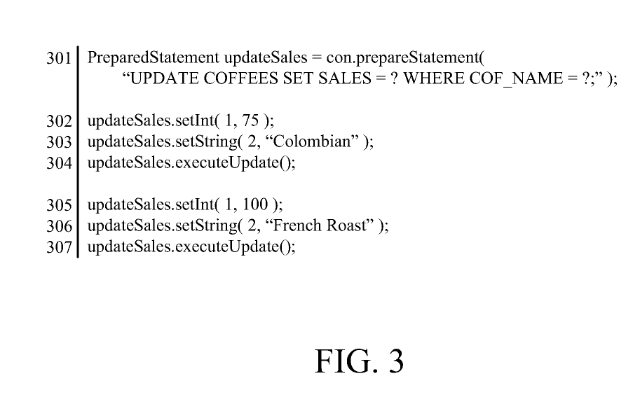

A flow chart illustrating execution of a series of database queries with a prepared statement according to one embodiment of the disclosure is shown in FIG. 2. The flow chart of FIG. 2 will be discussed below with reference to source code illustrating storing and executing a prepared statement with two sets of values according to one embodiment of the disclosure as shown in FIG. 3.

A method 200 begins at block 202 with storing a prepared statement. Line 301 of FIG. 3 is a statement created a new prepared statement defined as the database query “UPDATE COFFEES SET SALES=? WHERE COF NAME=?” The database query may be adapted for different languages, for example, by using a semi-colon to terminate the query string for JDBC, or by using a period to terminate the query string for a COBOL program. The database query is an update statement that updates a record in the table named COFFEES with a new sales value for a particular coffee name. The two values that should be supplied to complete the database query are a sales value and a coffee name.

Line 302 of FIG. 3 is a statement assigning the value ‘75’ to a first value. Line 303 is a statement assigning the value “Colombian” to a second value. The first value and the second value make up a first set of values for execution in the database query. Thus, executing the database query would result in updating a record in the COFFEES table corresponding to “Columbian” with a sales value of 75. Line 304 executes the update with the first set of values.

The method 200 proceeds to block 204 where the prepared statement is parsed. According to one embodiment, the prepared statement is also optimized. According to one embodiment, the parsing and optimizing of the prepared statement at block 204 may be performed before a database query is executed at line 304. According to another embodiment, the parsing and optimizing at block 204 may be performed only after a database query using the prepared statement has been requested. At block 206 the prepared statement is executed with the first set of values. The database may return data from the database system. In the case of an update statement, the database may return, for example, whether the database was successfully updated. The database may also return additional information such as whether the database has been altered since the prepared statement was parsed. Alternatively, the database may return information indicating that the prepared statement is no longer valid, such as when the database has been altered.

If the error does not indicate that the database schema (e.g., structure) has been altered, the method 200 proceeds to 208 to wait for execution of the prepared statement with a new set of values. Line 305 of FIG. 3 sets a new first value for coffee sales of 100. Line 306 sets a new value for coffee name of “French Roast.” Line 307 then executes the database query to update a record of the table COFFEES having a coffee name equal to “French Roast” to have sales of 100.

The results of the database query are returned after executing the prepared statement with a new set of values at block 208. Then, the method 200 continues to block 210. At block 210 the error is again examined to indicate if the database schema has been altered. If the database has not been altered the prepared statement may again be executed with a new set of values at block 208. If the database has been altered the method 200 proceeds to block 204 to re-parse and re-optimize the prepared statement in preparation for executing the prepared statement at block 206. According to one embodiment, if the execution of the prepared statement at 208 failed as a result of the database being altered, the prepared statement can again be executed with the set of values at block 206.

According to one embodiment, parsing and optimizing the prepared statement may create a section in a database interface such as a Java database connector (JDBC) when a ‘send_section’ request is made with the prepared statement. The returned section may include associated meta-data describing the section. The section may be executed by the JDBC on a database stored in a relational database management system (RDMS). When the section is executed with a set of values the RDMS may return an error message if the meta-data associated with the section in the JDBC is out-of-date, such as when the database in the RDMS has been altered. The ‘send_section’ request may be passed along with a packet communications area (PCA) for storing the section. If the PCA is too small to store the resulting section, an error may be generated. Other information may be returned in an ‘aux_info’ variable indicating a size needed for storing the section and a cursor description.

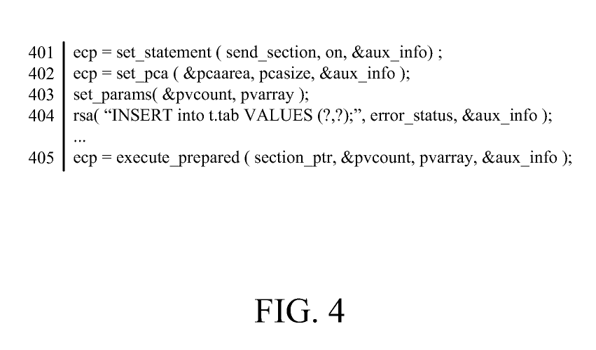

Programs may be written to interface with a language binding for executing database queries in a RDMS, storing prepared statements, and accessing sections. FIG. 4 is source code for a C program illustrating executing a prepared insert statement according to one embodiment of the disclosure. At line 401 the variable ‘ecp’ is set through the ‘set statement’ function to include the ‘send_section’ flag indicating the RDMS should create a section corresponding to the prepared statement and pointer to an aux_info variable for storing information returned from the RDMS. At line 402 the variable ‘ecp’ is set to including references to variables for the PCA through the ‘set_pca’ function. At line 403 a first set of ‘pvcount’ number of values stored in ‘pvarray’ are assigned for execution with the prepared statement. At line 404 an ‘INSERT’ prepared statement is sent to the RDMS for execution in the RDMS with the first set of values by the ‘rsa’ function resulting in parsing and optimizing of the ‘INSERT’ prepared statement. The prepared statement may be, for example, “INSERT into t.tab VALUES (?, ?),” where the questions marks are completed with values from the first set of values or a new set of values when executed.

After the ‘rsa’ function completes the RDMS returns to the program normal information, error status, and/or auxiliary information. The RDMS may also return the section and a header with an offset to the section in the PCA. The header may be, for example, four words in length. A user may calculate a pointer to the section and the header by adding the section offset of the PCA header to the PCA pointer. Later, the prepared statement may be executed again at line 405 with the ‘execute_prepared’ function, which may be passed the section pointer ‘section_ptr,’ a count for a second set of values ‘pvcount,’ an array of the second set of values ‘pvarray,’ and auxiliary information ‘aux_info.’ When the ‘execute_prepared’ function is called the prepared statement may be executed without re-parsing and re-optimizing the prepared statement if the database has not been altered.

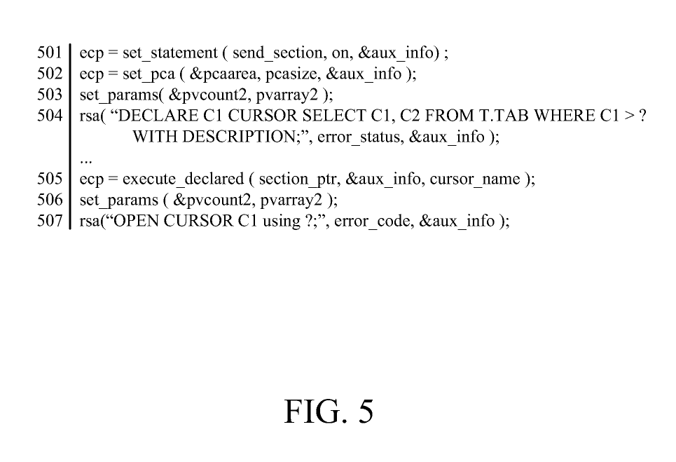

The source code of FIG. 4 may be adapted for other database query statements including INSERT, UPDATE, LOCK, DECLARE, TRUNCATE, DELETE, and DELETE ALL commands. A DECLARE statement is demonstrated in FIG. 5, which illustrates source code for executing a statement with a defined cursor according to one embodiment of the disclosure. Lines 501, 502, and 503 are similar to lines 401, 402, and 403 of FIG. 4. At line 504 the ‘rsa’ function is called with a ‘DECLARE’ statement. The ‘DECLARE’ statement may be, for example. “DECLARE C1 CURSOR SELECT C1, C2 FROM T.TAB WHERE C1>? WITH DESCRIPTION,” where the questions marks are completed with values from the first set of values or a new set of values when executed.

A user may execute the ‘SELECT’ statement multiple times without re-parsing the prepared statement if the database is not altered. At line 505 the ‘execute declared’ function is called with the pointer to the section. At line 506 a new set of ‘pvcount2’ values from ‘pvarray2’ is assigned. At line 507 the ‘rsa’ function executes the ‘SELECT’ database query stored as a cursor with the new set of values. The ‘rsa’ function may return an error code in the ‘error code’ variable indicating if the prepared statement executed successfully. The error code may indicate, for example, that the prepared statement could not be executed because the database has been altered since the prepared statement was parsed. According to one embodiment, a user may instead execute the declared statement with an ‘open cursor’ function by passing the cursor name and new set of values.

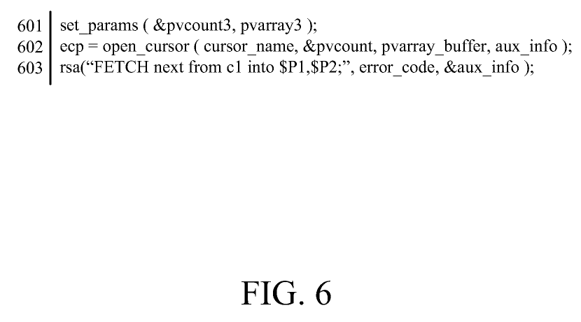

After a ‘SELECT’ statement is executed as shown in, for example, FIG. 5, the selected records may be fetched from the database with the source code illustrated in FIG. 6. At line 601 a new set of values is selected for execution with the prepared statement. At line 602 a previously declared ‘CURSOR’ statement is opened. At line 603 a ‘FETCH’ statement is executed by the ‘rsa’ function to fetch the resulting records selected by the ‘SELECT’ statement.

According to one embodiment, RDMS may handle variable length parameters in the prepared statement by appending a corresponding command packet to the section returned in the PCA. When an “EXECUTE PREPARED (INSERT, UPDATE, DELETE)” statement is issued and the parameter values in the data packet do not match the data type or the data scale or the length of a parameter value is larger than the prepared length, RDMS may use the new parameter values and the saved command packet to rebuild a new section corresponding to the prepared statement. This new section may then be executed and discarded. A subsequent “EXECUTE PREPARED” may rebuild a new section or the values of the parameters in its data packet. If the length of the variable length item is smaller or equal to the length of the variable when the section was created the section's variable area can be initialized without error, thus allowing the prepared statement to execute.

Although meta-data becoming out-of-date is described above, according to one embodiment the meta-data may also become invalid when the values passed as parameters affect the size, scale, or data type of the data returned by the database query. RDMS may detect this by comparing a record description format of the invalid section with a record description format of the re-optimized section. When the meta-data is invalid the RDMS may return a warning status and execute the database query.

A parameter error for the ‘OPEN’ cursor may be handled separate from certain other errors. According to one embodiment, when a cursor is declared with ‘send_section’ or declared through an ‘execute declared’ function, a corresponding command packet may be placed directly after the section in the cursor packet pointed to by the section address. The command packet may be used to re-optimize, or create a new section, using the new parameter values, also known as program variable values.

The methods described above for storing database queries, such as SQL commands, as prepared statements, and parsing the prepared statements once for a series of similar database queries with different values may decrease processor utilization. Thus, a database system executing with the improved functionality may operate faster and have improved capacity compared with conventional database systems. Additionally, storing meta-data regarding the section obtained from the RDMS allows the RDMS to continue operation without a lock or registration on table definitions within the database. Thus, the table definition (schema) can be updated without impacting the operation of JDBC, except for possibly re-parsing the prepared statements.

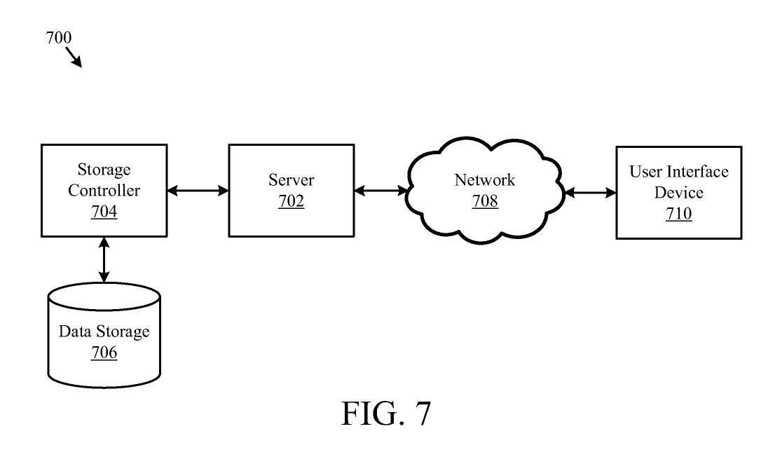

FIG. 7 illustrates one embodiment of a system 700 for an information system. The system 700 may include a server 702, a data storage device 706, a network 708, and a user interface device 710. The server 702 may be a dedicated server or one server in a cloud computing system. In a further embodiment, the system 700 may include a storage controller 704, or storage server configured to manage data communications between the data storage device 706, and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or table computer, a smartphone or other a mobile communication device or organizer device having access to the network 708. In a further embodiment, the user interface device 710 may access the Internet or other wide area or local area network to access a web application or web service hosted by the server 702 and provide a user interface for enabling a user to enter or receive information.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 710 accesses the server 702 through an intermediate server (not shown). For example, in a cloud application the user interface device 710 may access an application server. The application server fulfills requests from the user interface device 710 by accessing a database management system (DBMS). In this embodiment, the user interface device 710 may be a computer executing a Java application making requests to a JBOSS server executing on a Linux server, which fulfills the requests by accessing a relational database management system (RDMS) on a mainframe server.

In one embodiment, the server 702 is configured to store databases, pages, tables, and/or records. For example, the server 702 may store news stories or patient histories. Additionally, scripts on the server 702 may access data stored in the data storage device 706 via a Storage Area Network (SAN) connection, a LAN, a data bus, or the like. The data storage device 706 may include a hard disk, including hard disks arranged in an Redundant Array of Independent Disks (RAID) array, a tape storage drive comprising a physical or virtual magnetic tape data storage device, an optical storage device, or the like. The data may be arranged in a database and accessible through Structured Query Language (SQL) queries, or other data base query languages or operations.

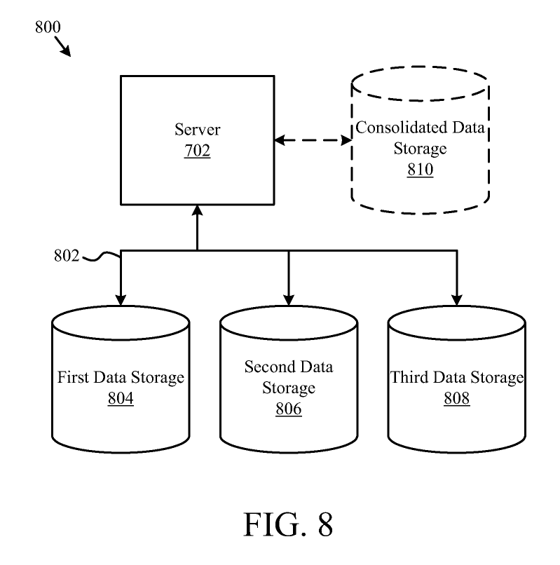

FIG. 8 illustrates one embodiment of a data management system 800 configured to store measured data from a sensor network. In one embodiment, the data management system 800 may include the server 702. The server 702 may be coupled to a data-bus 802. In one embodiment, the data management system 800 may also include a first data storage device 804, a second data storage device 806, and/or a third data storage device 808. In further embodiments, the data management system 800 may include additional data storage devices (not shown). In such an embodiment, each data storage device 804, 806, and 808 may each host a separate database that may, in conjunction with the other databases, contain redundant data. Alternatively, a database may be spread across storage devices 804, 806, and 808 using database partitioning or some other mechanism. Alternatively, the storage devices 804, 806, and 808 may be arranged in a RAID configuration for storing a database or databases through may contain redundant data. Data may be stored in the storage devices 804, 806, 808, 810 in a database management system (DBMS), a relational database management system (RDMS), an Indexed Sequential Access Method (ISAM) database, a Multi Sequential Access Method (MSAM) database, a Conference on Data Systems Languages (CODASYL) database, or other database system.

In one embodiment, the server 702 may submit a query to select data from the storage devices 804 and 806. The server 702 may store consolidated data sets in a consolidated data storage device 810. In such an embodiment, the server 702 may refer back to the consolidated data storage device 810 to obtain a set of records. Alternatively, the server 702 may query each of the data storage devices 804, 806, and 808 independently or in a distributed query to obtain the set of data elements. In another alternative embodiment, multiple databases may be stored on a single consolidated data storage device 810.

In various embodiments, the server 702 may communicate with the data storage devices 804, 806, and 808 over the data-bus 802. The data-bus 802 may comprise a Storage Area Network (SAN), a Local Area Network (LAN), or the like. The communication infrastructure may include Ethernet, Fibre-Chanel Arbitrated Loop (FC-AL), Fibre-Channel over Ethernet (FCoE), Small Computer System Interface (SCSI), Internet Small Computer System Interface (iSCSI), Serial Advanced Technology Attachment (SATA), Advanced Technology Attachment (ATA), Cloud Attached Storage, and/or other similar data communication schemes associated with data storage and communication. For example, the server 702 may communicate indirectly with the data storage devices 804, 806, 808, and 810 by first communicating with a storage server (not shown) or the storage controller 704.

The server 702 may include modules for interfacing with the data storage devices 804, 806, 808, and 810, interfacing a network 708, and/or interfacing with a user through the user interface device 710. In a further embodiment, the server 702 may host an engine, application plug-in, or application programming interface (API) or a database interface such as a Java database connector (JDBC).

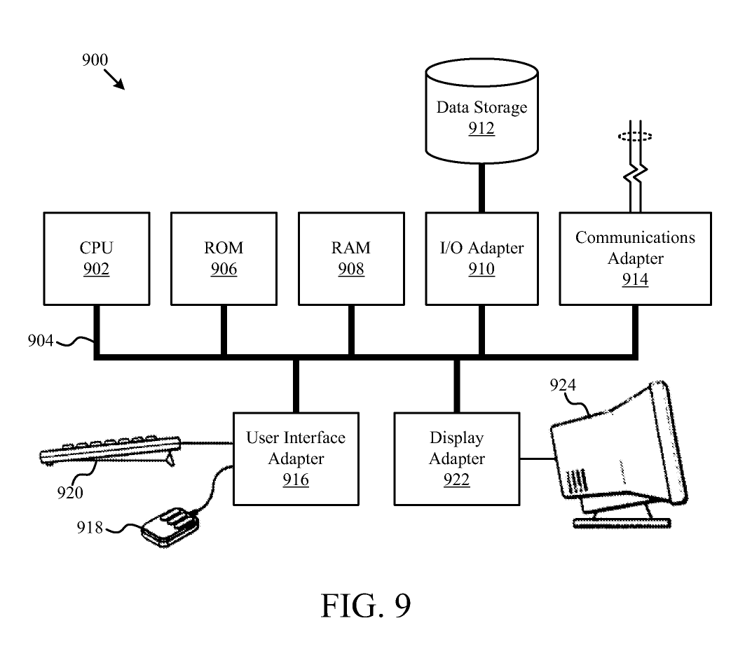

FIG. 9 illustrates a computer system 900 adapted according to certain embodiments of the server 702 and/or the user interface device 710. The central processing unit (“CPU”) 902 is coupled to the system bus 904. The CPU 902 may be a general purpose CPU or microprocessor, graphics processing unit (“GPU”), and/or microcontroller. The present embodiments are not restricted by the architecture of the CPU 902 so long as the CPU 902, whether directly or indirectly, supports the modules and operations as described herein. The CPU 902 may execute the various logical instructions according to the present embodiments.

The computer system 900 also may include random access memory (RAM) 908, which may be SRAM, DRAM, and/or SDRAM. The computer system 900 may utilize RAM 908 to store the various data structures used by a software application such as databases, tables, and/or records. The computer system 900 may also include read only memory (ROM) 906 which may be PROM, EPROM, EEPROM, or optical storage. The ROM may store configuration information for booting the computer system 900. The RAM 908 and the ROM 906 hold user and system data.

The computer system 900 may also include an input/output (I/O) adapter 910, a communications adapter 914, a user interface adapter 916, and a display adapter 922. The I/O adapter 910 and/or the user interface adapter 916 may, in certain embodiments, enable a user to interact with the computer system 900. In a further embodiment, the display adapter 922 may display a graphical user interface (GUI) associated with a software or web-based application on a display device 924, such as a monitor or touch screen.

The I/O adapter 910 may connect one or more storage devices 912, such as one or more of a hard drive, a compact disc (CD) drive, a floppy disk drive, and a tape drive, to the computer system 900. The communications adapter 914 may be adapted to couple the computer system 900 to the network 708, which may be one or more of a LAN, WAN, and/or the Internet. The communications adapter 914 may be adapted to couple the computer system 900 to a storage device 912. The user interface adapter 916 couples user input devices, such as a keyboard 920, a pointing device 918, and/or a touch screen (not shown) to the computer system 900. The display adapter 922 may be driven by the CPU 902 to control the display on the display device 924.

The applications of the present disclosure are not limited to the architecture of computer system 900. Rather the computer system 900 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. For example, append, modify, and truncate statements may substitute for insert, update, and delete statements. Other database systems and languages may have yet different names for similarly functioning statements. Moreover, the scope of the present application is not intended to be limited to the particular embodiments of the process, machine, manufacture, composition of matter, means, methods and steps described in the specification. For example, although embodiments describe the JDBC database interface, other interfaces such as OLE/DB, ODBC, ADO.NET, SPARQL, and other database interface technologies may implement the disclosure of this application. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
storing a prepared statement having at least one variable for execution by a database interface in a database;
assigning at least one first value to the at least one variable;
parsing the prepared statement;
executing the parsed prepared statement with the at least one first value;
assigning at least one second value to the at least one variable; and
executing the parsed prepared statement with the at least one second value.

2. The method of claim 1, further comprising receiving, at the database interface, an error message indicating the database has been altered.

3. The method of claim 2, further comprising re-parsing the prepared statement after receiving the error message indicating the database has been altered.

4. The method of claim 1, in which the prepared statement is at least one of a select statement, an insert statement, an update statement, and a delete statement.

5. The method of claim 1, further comprising optimizing the prepared statement after parsing the prepared statement and before executing the prepared statement with the at least one first value.

6. The method of claim 1, further comprising receiving, from the database, a pointer to a PCA header after executing the parsed prepared statement, the PCA header having a section corresponding to the prepared statement and an offset value.

7. The method of claim 6, further comprising calculating a pointer to the section by adding the offset value to the pointer to the PCA header, in which the step of executing the prepared statement comprises calling the section by referencing the section pointer.

8. The method of claim 1, in which the database interface is a Java database connector (JDBC) and the database is a relational database management system (RDMS).

9. A computer program product, comprising:
a non-transitory computer readable medium comprising:
code to store a prepared statement having at least one variable for execution by a database interface in a database;
code to assign at least one first value to the at least one variable;
code to parse the prepared statement;
code to execute the parsed prepared statement with the at least one first value;
code to assign at least one second value to the at least one variable; and
code to execute the parsed prepared statement with the at least one second value.

10. The computer program product of claim 9, in which the medium further comprises code to receive, at the database interface, an error message indicating the database has been altered.

11. The computer program product of claim 10, in which the medium further comprises code to re-parse the prepared statement after receiving the error message indicating the database has been altered.

12. The computer program product of claim 9, in which the prepared statement is at least one of a select statement, an insert statement, an update statement, and a delete statement.

13. The computer program product of claim 9, in which the medium further comprises code to optimize the prepared statement after parsing the prepared statement and before executing the prepared statement with the at least one first value.

14. The computer program product of claim 9, in which the database interface is a Java database connector (JDBC) and the database is a relational database management system (RDMS).

15. A system, comprising:
at least one processor coupled to a memory, in which the at least one processor is configured:
to store a prepared statement having at least one variable for execution by a database interface in a database;
to assign at least one first value to the at least one variable;
to parse the prepared statement;
to execute the parsed prepared statement with the at least one first value;
to assign at least one second value to the at least one variable; and
to execute the parsed prepared statement with the at least one second value.

16. The system of claim 15, in which the at least one processor is further configured to receive, at the database interface, an error message indicating the database has been altered.

17. The system of claim 16, in which the at least one processor is further configured to re-parse the prepared statement after receiving the eror message indicating the database has been altered.

18. The system of claim 15, in which the prepared statement is at least one of a select statement, an insert statement, an update statement, and a delete statement.

19. The system of claim 15, in which the at least one processor is further configured to optimize the prepared statement after parsing the prepared statement and before executing the prepared statement with the at least one first value.

20. The system of claim 15, in which the database interface is a Java database connector (JDBC) and the database is a relational database management system (RDMS).
